(19) United States
(12) Patent Application Publication
(10) Pub. No.: US 2010/0185475 A1
(43) Pub. Date: Jul. 22, 2010

(54) Three Dimensional Virtual Planning

(76) Inventor: Michael R. Holle, Kent, WA (US)

Correspondence Address: DUKE W. YEE, YEE & ASSOCIATES, P.C., P.O. BOX 802333, DALLAS, TX, 75380, US

(21) Appl. No.: 12/357,128

(22) Filed: Jan. 21, 2009

(51) Int. Cl. G06Q 10/00; G06F 17/30

(52) U.S. Cl. 705/7; 707/E17.044

(57) ABSTRACT

A computer implemented method, apparatus, and computer program product for generating maintenance plans. An embodiment of the invention includes obtaining information from a number of databases in response to receiving a request to generate a maintenance plan for a structure. A maintenance need for the structure is determined using the information obtained from the number of databases. A number of tasks required to meet the maintenance need are determined using the information obtained from the number of databases. A three dimensional task simulation for each task in the number of tasks required to meet the maintenance need is identified using the information obtained from the number of databases to form a number of three dimensional task simulations. The number of three dimensional task simulations for the number of tasks required is compiled into a sequence of three dimensional task simulations to form the maintenance plan.

### BACKGROUND INFORMATION

1. Field

The present disclosure relates generally to an improved design and data processing system and, in particular, to a method and apparatus for maintenance and repair planning of products. Still more particularly, the present disclosure relates to a computer implemented method, apparatus, and computer usable program code for generating three dimensional maintenance planning processes.

2. Background

A product may take various forms, such as, for example, a single part, a subassembly, or an entire product. As a non limiting example, the product may take the form of a wing subassembly, an engine, an audio input system, a wing spar, a flight control system, or an entire aircraft.

In planning for maintenance and repair of products, a number of different processes may be present. When the product is an aircraft, for example, computer based maintenance planning tools may aid in the planning process by integrating regulatory requirements with emerging maintenance needs to help calculate the time required to perform the many tasks necessary to keep the aircraft in airworthy condition and compliant with federal regulations.

Technical data, such as the maintenance manual, is reviewed and interpreted to aid in developing and sequencing the myriad of activities needed to complete the work. The technical data provides little or no visual reference as to the status of the aircraft configuration at any one time in the life cycle of the complete maintenance session. The two dimensional illustrated tasks that generally accompany maintenance manual tasks are usually completely independent of each other, but are used as a reference to try and piece together a complex, integrated series of events that must flow smoothly and seamlessly together as a single, orchestrated event.

An aircraft maintenance planner must have extensive knowledge of all potential activities and aircraft configurations to effectively plan, bid, and execute a series of complex, highly technical tasks. The maintenance planners rely on past experience, two dimensional illustrated text, generic estimates, and their own imagination to develop a list of tasks needed to be performed, and then arrange them into some sort of logical sequence of events to ensure all required maintenance is accomplished with the minimum expenditure of cost, time, and resources.

Multiple planners providing input to a single session can further complicate the planning. This complication may include conflicting maintenance configuration issues, such as whether the aircraft is on or off jacks, or a system has power or no power. Existing tools offer only static, two dimensional illustrated drawings as visual reference to what the configuration of the aircraft might be at some time during the maintenance task. The two dimensional reference of a given configuration is independent of any other tasks that may be occurring simultaneous to the task associated with the given configuration. Planner A could easily schedule a functional maintenance task during the time Planner B needs to have the same system shut down or would have people or equipment in harm's way.

### SUMMARY

The advantageous embodiments provide a computer implemented method, apparatus, and computer program product for generating maintenance plans. An embodiment of the invention includes obtaining information from a number of databases in response to receiving a request to generate a maintenance plan for a structure. A maintenance need for the structure is determined using the information obtained from the number of databases. A number of tasks required to meet the maintenance need are determined using the information obtained from the number of databases. A three dimensional task simulation for each task in the number of tasks required to meet the maintenance need is identified using the information obtained from the number of databases to form a number of three dimensional task simulations. The number of three dimensional task simulations for the number of tasks required is compiled into a sequence of three dimensional task simulations to form the maintenance plan.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the advantageous embodiments are set forth in the appended claims. The advantageous embodiments, however, as well as a preferred mode of use, further objectives and advantages thereof, will best be understood by reference to the following detailed description of an advantageous embodiment of the present disclosure when read in conjunction with the accompanying drawings, wherein:

FIG. 1 is a diagram illustrating an aircraft manufacturing and service method in accordance with an advantageous embodiment;

FIG. 2 is a diagram of an aircraft in which an advantageous embodiment may be implemented;

FIG. 3 is a diagram of a maintenance environment in accordance with an advantageous embodiment;

FIG. 4 is a diagram of a data processing system in accordance with an advantageous embodiment;

FIG. 5 is a diagram of a three dimensional maintenance planning system in accordance with an advantageous embodiment;

FIG. 6 is a diagram of a maintenance planning tool in accordance with an advantageous embodiment;

FIG. 7 is a diagram of a user interface in accordance with an advantageous embodiment;

FIG. 8 is a diagram of a plurality of databases in accordance with an advantageous embodiment;

FIG. 9 is a diagram of a three dimensional simulation database in accordance with an advantageous embodiment;

FIG. 10 is a diagram of a maintenance planning database in accordance with an advantageous embodiment;

FIG. 11 is a diagram of a current aircraft status database in accordance with an advantageous embodiment;

FIG. 12 is a diagram of a resource database in accordance with an advantageous embodiment;

FIG. 13 is a diagram of an aircraft maintenance history database in accordance with an advantageous embodiment;

FIG. 14 is a diagram of a three dimensional maintenance plan generated by a three dimensional maintenance planning tool in accordance with an advantageous embodiment;

FIG. 15 is a flowchart illustrating a process for generating a maintenance plan in accordance with an advantageous embodiment;

FIG. 16 is a flowchart illustrating a process for determining maintenance needs in accordance with an advantageous embodiment; and

FIG. 17 is a flowchart illustrating a process for performing a maintenance operation in accordance with an advantageous embodiment.

### DETAILED DESCRIPTION

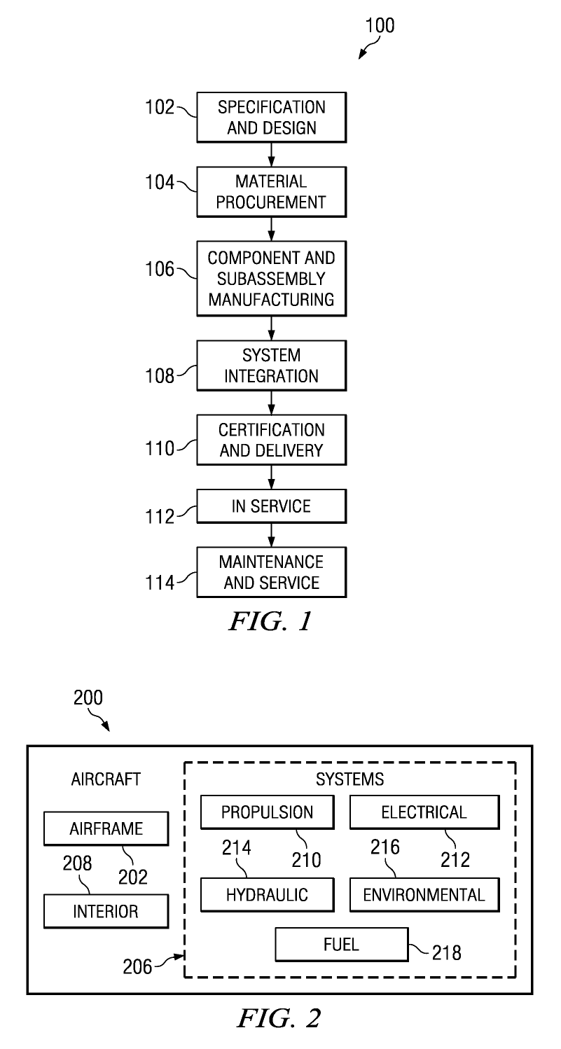

Referring more particularly to the drawings, embodiments of the disclosure may be described in the context of the aircraft manufacturing and service method 100 as shown in FIG. 1 and aircraft 200 as shown in FIG. 2. Turning first to FIG. 1, a diagram illustrating an aircraft manufacturing and service method is depicted in accordance with an advantageous embodiment. During pre-production, exemplary aircraft manufacturing and service method 100 may include specification and design 102 of aircraft 200 in FIG. 2 and material procurement 104.

During production, component and subassembly manufacturing 106 and system integration 108 of aircraft 200 in FIG. 2 takes place. Thereafter, aircraft 200 in FIG. 2 may go through certification and delivery 110 in order to be placed in service 112. While in service by a customer, aircraft 200 in FIG. 2 is scheduled for routine maintenance and service 114, which may include modification, reconfiguration, refurbishment, and other maintenance or service.

Each of the processes of aircraft manufacturing and service method 100 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of venders, subcontractors, and suppliers; and an operator may be an airline, leasing company, military entity, service organization, and so on.

With reference now to FIG. 2, a diagram of an aircraft is depicted in which an advantageous embodiment may be implemented. In this example, aircraft 200 is produced by aircraft manufacturing and service method 100 in FIG. 1 and may include airframe 202 with a plurality of systems 204 and interior 206. Examples of systems 204 include one or more of propulsion system 208, electrical system 210, hydraulic system 212, and environmental system 214. Any number of other systems may be included. Although an aerospace example is shown, different advantageous embodiments may be applied to other industries, such as the automotive industry.

Apparatus and methods embodied herein may be employed during any one or more of the stages of aircraft manufacturing and service method 100 in FIG. 1. For example, materials procured during material procurement 104 in FIG. 1 may be procured while aircraft 200 is in maintenance and service 114 in FIG. 1.

Also, one or more apparatus embodiments, method embodiments, or a combination thereof may be utilized during production stages, such as component and subassembly manufacturing 106 and system integration 108 in FIG. 1, for example, without limitation, by substantially expediting the assembly of or reducing the cost of aircraft 200. Similarly, one or more of apparatus embodiments, method embodiments, or a combination thereof may be utilized while aircraft 200 is in service 112 or during maintenance and service 114 in FIG. 1.

For example, different advantageous embodiments may be employed to create work instructions for a maintenance session during maintenance and service 114. Advantageous embodiments also may be implemented to obtain work instructions during component and subassembly manufacturing 106, system integration 108, and/or maintenance and service 114.

The different advantageous embodiments recognize and take into account that currently used systems for generating maintenance plans require an operator, a maintenance planner, or other person to review technical data for products, such as a maintenance manual, and generate work instructions for a maintenance session from that technical data. The different advantageous embodiments also recognize and take into account that this technical data is accompanied by two dimensional illustrated tasks that are independent from other tasks, but are used by the operator or planner to try and piece together a complex, integrated series of events. The different advantageous embodiments also recognize that limitations arise in maintenance sessions due to resource availability, limited two dimensional illustrated configurations, and the impact individual tasks may have on each other.

Thus, the different advantageous embodiments provide a method, apparatus, and computer program product for generating three dimensional maintenance planning processes. The different advantageous embodiments may obtain information from a number of databases in response to receiving a request to generate a maintenance plan for a structure. A maintenance need for the structure is determined using the information obtained from the number of databases. A number of tasks required to meet the maintenance need are determined using the information obtained from the number of databases. A three dimensional task simulation for each task in the number of tasks required to meet the maintenance need is identified using the information obtained from the number of databases to form a number of three dimensional task simulations. The number of three dimensional task simulations for the number of tasks required is compiled into a sequence of three dimensional task simulations to form the maintenance plan.

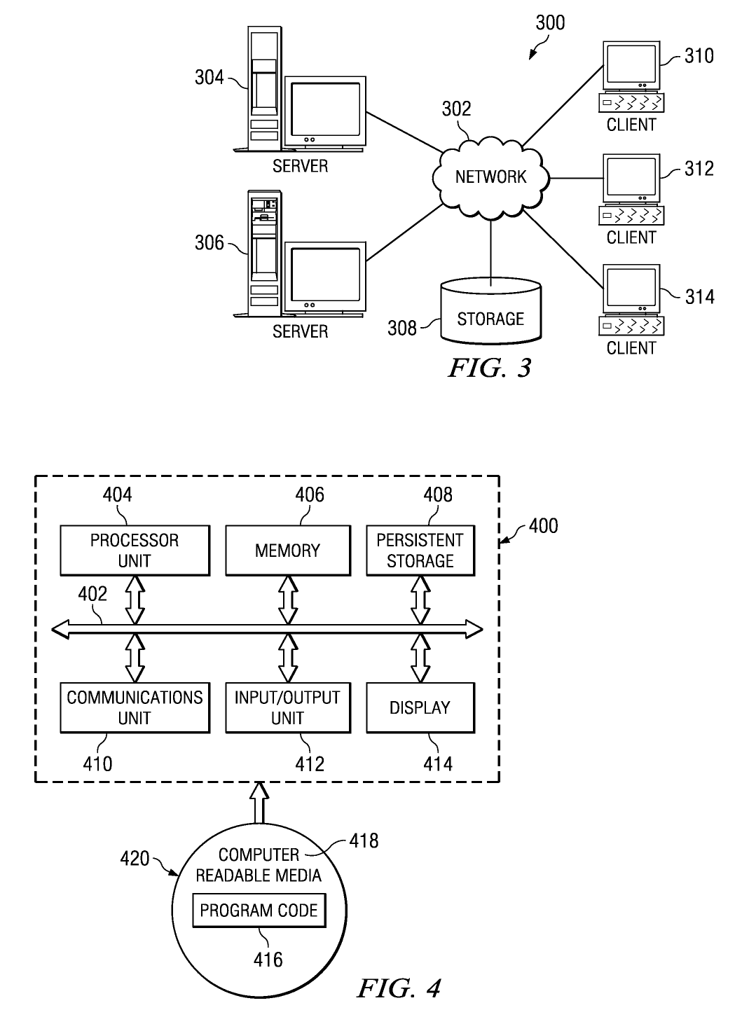

With reference now to FIGS. 3-4, exemplary diagrams of data processing environments are provided in which advantageous embodiments may be implemented. It should be appreciated that FIGS. 3-4 are only exemplary and are not intended to assert or imply any limitation with regard to the environments in which different embodiments may be implemented. Many modifications to the depicted environments may be made.

FIG. 3 depicts a pictorial representation of a network of data processing systems in which advantageous embodiments may be implemented. Network data processing system 300 may be used during aircraft manufacturing and service method 100 in FIG. 1. For example, network data processing system 300 may be used to create work instructions and distribute them for use during maintenance and service 114 in FIG. 1.

Network data processing system 300 is a network of computers in which the advantageous embodiments may be implemented. Network data processing system 300 contains network 302, which is the medium used to provide communications links between various devices and computers connected together within network data processing system 300. Network 302 may include connections, such as wire, wireless communication links, or fiber optic cables.

In the depicted example, server 304 and server 306 connect to network 302 along with storage unit 308. In addition, clients 310, 312, and 314 connect to network 302. Clients 310, 312, and 314 may be, for example, personal computers or network computers. In the depicted example, server 304 provides data, such as boot files, operating system images, and applications, such as electronic mail applications and calendar applications, to clients 310, 312, and 314. Clients 310, 312, and 314 are clients to server 304 in this example. Network data processing system 300 may include additional servers, clients, and other devices not shown.

The different components of network data processing system 300 may be distributed across various locations. In an advantageous embodiment, server 304 and server 306 may be located at an aircraft manufacturer. Clients 310, 312, and 314 may be located at an airline's maintenance facility, a manufacturer's maintenance facility, or a third party maintenance facility.

In the depicted example, network data processing system 300 is the Internet with network 302 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 300 also may be implemented as a number of different types of networks, such as, for example, an intranet, a local area network (LAN), or a wide area network (WAN). FIG. 3 is intended as an example, and not as an architectural limitation for the different advantageous embodiments.

Turning now to FIG. 4, a diagram of a data processing system is depicted in accordance with an advantageous embodiment. Data processing system 400 may be used to implement various computers and/or devices used in the different advantageous embodiments. For example, data processing system 400 may be an example of network data processing system 300 in FIG. 3. Data processing system 400 may be used to implement servers such as server 304, and server 306 in FIG. 3.

In this illustrative example, data processing system 400 includes communications fabric 402, which provides communications between processor unit 404, memory 406, persistent storage 408, communications unit 410, input/output (I/O) unit 412, and display 414.

Processor unit 404 serves to execute instructions for software that may be loaded into memory 406. Processor unit 404 may be a set of one or more processors or may be a multi-processor core, depending on the particular implementation. Further, processor unit 404 may be implemented using one or more heterogeneous processor systems in which a main processor is present with secondary processors on a single chip. As another illustrative example, processor unit 404 may be a symmetric multi-processor system containing multiple processors of the same type.

Memory 406 and persistent storage 408 are examples of storage devices. A storage device is any piece of hardware that is capable of storing information either on a temporary basis and/or a permanent basis. Memory 406, in these examples, may be, for example, a random access memory or any other suitable volatile or non-volatile storage device.

A storage device, as used herein, is hardware that is capable of storing computer program code in the functional form and/or data. Persistent storage 408 may take various forms depending on the particular implementation. For example, persistent storage 408 may contain one or more components or devices. For example, persistent storage 408 may be a hard drive, a flash memory, a rewritable optical disk, a rewritable magnetic tape, or some combination of the above. The media used by persistent storage 408 also may be removable. For example, a removable hard drive may be used for persistent storage 408.

Communications unit 410, in these examples, provides for communications with other data processing systems or devices. In these examples, communications unit 410 is a network interface card. Communications unit 410 may provide communications through the use of either or both physical and wireless communications links.

Input/output unit 412 allows for input and output of data with other devices that may be connected to data processing system 400. For example, input/output unit 412 may provide a connection for user input through a keyboard and mouse. Further, input/output unit 412 may send output to a printer. Display 414 provides a mechanism to display information to a user.

Instructions for the operating system and applications or programs are located on persistent storage 408. These instructions may be loaded into memory 406 for execution by processor unit 404. The processes of the different embodiments may be performed by processor unit 404 using computer implemented instructions, which may be located in a memory, such as memory 406. These instructions are referred to as program code, computer usable program code, or computer readable program code that may be read and executed by a processor in processor unit 404. The program code in the different embodiments may be embodied on different physical or tangible computer readable media, such as memory 406 or persistent storage 408.

Program code 416 is located in a functional form on computer readable media 418 that is selectively removable and may be loaded onto or transferred to data processing system 400 for execution by processor unit 404. Program code 416 and computer readable media 418 form computer program product 420 in these examples. In one example, computer readable media 418 may be in a tangible form, such as, for example, an optical or magnetic disc that is inserted or placed into a drive or other device that is part of persistent storage 408 for transfer onto a storage device, such as a hard drive that is part of persistent storage 408. In a tangible form, computer readable media 418 also may take the form of a persistent storage, such as a hard drive, a thumb drive, or a flash memory that is connected to data processing system 400. The tangible form of computer readable media 418 is also referred to as computer recordable storage media. In some instances, computer readable media 418 may not be removable.

Alternatively, program code 416 may be transferred to data processing system 400 from computer readable media 418 through a communications link to communications unit 410 and/or through a connection to input/output unit 412. The communications link and/or the connection may be physical or wireless in the illustrative examples. The computer readable media also may take the form of non-tangible media, such as communications links or wireless transmissions containing the program code.

In some advantageous embodiments, program code 416 may be downloaded over a network to persistent storage 408 from another device or data processing system for use within data processing system 400. For instance, program code stored in a computer readable storage medium in a server data processing system may be downloaded over a network from the server to data processing system 400. The data processing system providing program code 416 may be a server computer, a client computer, or some other device capable of storing and transmitting program code 416.

The different components illustrated for data processing system 400 are not meant to provide architectural limitations to the manner in which different embodiments may be implemented. The different advantageous embodiments may be implemented in a data processing system including components in addition to or in place of those illustrated for data processing system 400. Other components shown in FIG. 4 can be varied from the illustrative examples shown. The different embodiments may be implemented using any hardware device or system capable of executing program code. As one example, the data processing system may include organic components integrated with inorganic components and/or may be comprised entirely of organic components excluding a human being. For example, a storage device may be comprised of an organic semiconductor.

As another example, a storage device in data processing system 400 is any hardware apparatus that may store data. Memory 406, persistent storage 408 and computer readable media 418 are examples of storage devices in a tangible form.

In another example, a bus system may be used to implement communications fabric 402 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 406 or a cache such as found in an interface and memory controller hub that may be present in communications fabric 402.

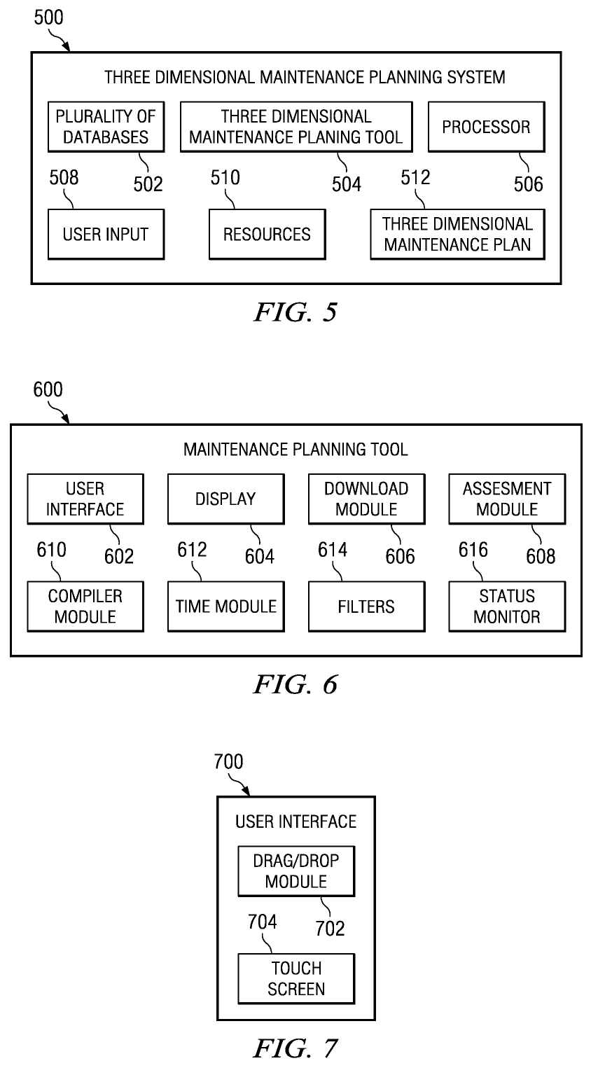

With reference now to FIG. 5, a diagram of a three dimensional maintenance planning system is depicted in accordance with an advantageous embodiment. Three dimensional maintenance planning system 500 may be implemented by a data processing system, such as data processing system 400 in FIG. 4, within a network environment, such as network data processing system 300 in FIG. 3, for example. Three dimensional maintenance planning system 500 may be implemented during an aircraft manufacturing and service method, such as maintenance and service 114 in FIG. 1 for example.

Three dimensional maintenance planning system 500 includes plurality of databases 502, which contains information on the product, tasks, needed or scheduled maintenance, current product status, resources available, maintenance history, past maintenance plans, and other information needed to create a maintenance plan. Plurality of databases 502 may be located in a storage device, such as storage 308 in FIG. 3, at a server, such as server 304 in FIG. 3, or distributed over many data processing systems.

The information from plurality of databases 502 is used by three dimensional maintenance planning tool 504 to generate three dimensional virtual planning processes. Three dimensional maintenance planning tool 504 uses processor 506 to analyze the information from plurality of databases 502 and determine which maintenance tasks are needed in a given maintenance session.

Three dimensional maintenance planning tool 504 may also use processor 506 to analyze information from user input 508. Processor 506 may be integrated with three dimensional maintenance planning tool 504, or remote from three dimensional maintenance planning tool 504. Processor 506 is an example of a process that may execute on processor unit 404 in FIG. 4. Three dimensional maintenance planning system 500 includes resources 510, which may include personnel, tools, supplies, workspace, and other resources necessary to complete a maintenance task or series of tasks in a maintenance session.

In an illustrative example, user input 508 prompts three dimensional planning tool 504 to obtain information from plurality of databases 502 in order to generate three dimensional maintenance plan 512 using processor 506. Three dimensional maintenance plan 512 may include a sequence of three dimensional task simulations, which provide a three dimensional view of a series of tasks being performed in a maintenance operation. Each three dimensional task simulation may provide a three dimensional view of the parts or components of the structure on which the maintenance operation is being performed.

The illustration of three dimensional maintenance planning system 500 in FIG. 5 is not meant to imply physical or architectural limitations on the manner in which different advantageous embodiments may be implemented. Other components in addition or in place of the ones illustrated may be used. Some components may be unnecessary in some advantageous embodiments. Also, the blocks are presented to illustrate some functional components and combined and/or divided into different blocks when implemented in hardware and/or software.

For example, in some advantageous embodiments, plurality of databases 502 could be implemented as a single database. Also, plurality of databases 502 may be located at the same data processing system or distributed over many data processing systems.

With reference now to FIG. 6, a diagram of a maintenance planning tool is depicted in accordance with an advantageous embodiment. Maintenance planning tool 600 is an illustrative example of one implementation of three dimensional maintenance planning tool 504 in FIG. 5.

Maintenance planning tool 600 includes user interface 602, display 604, download module 606, assessment module 608, compiler module 610, time module 612, filters 614, and status monitor 616. User interface 602 allows for a maintenance planner to input data into maintenance planning tool 600 as well as receive and view information from maintenance planning tool 600. User interface 602 may be, in one advantageous embodiment, presented on a display monitor, such as display 604, viewable by a maintenance planner. Display 604 may display information retrieved from a number of databases by download module 606, as well as messages, alerts, and queries for the maintenance planner. In another advantageous embodiment, user interface may also include peripherals such as, for example, a keyboard and mouse configured to interact with a monitor integrated with display 604.

The information download module 606 pulls from the number of databases used by assessment module 608 to determine the maintenance needs for a particular product or maintenance session. Compiler module 610 formats the information retrieved by download module 606, as well as any user input received at user interface 602, into a format that can be presented to the user via display 604. Assessment module 608 may be integrated with compiler module 610 or may be a separate component that works with compiler module 610 to present a sequence of a number of tasks or events that meet the maintenance needs for a particular product or maintenance session to the user.

For example, in an advantageous embodiment, user input may be received in the form of a message indicating that component A is inoperable. Maintenance planning tool 600 may retrieve a number of tasks for possible action and present them in a sequence. An example of a sequence is as follows: (a) prepare product for maintenance, (b) access component A, (c) execute fault isolation procedures, (d) execute removal procedures, (e) execute installation procedures, (f) execute servicing procedures, (g) execute test procedures, (h) execute close procedures, and (i) return to service procedures.

Optionally, assessment module 608 may place the number of tasks or events in an order that meets the maintenance needs determined into a flow of tasks or events that is most efficient. A user may use user interface 602 to re-order the tasks or events into any number of different configurations of tasks and/or events until the desired maintenance plan is achieved.

Time module 612 works with assessment module 608 to analyze the time increments of each individual task or event, and compute the estimated time for a maintenance plan or session. Time module 612 may also be used in conjunction with status monitor 616 to monitor the progress of an on-going maintenance plan or session. Time module 612 may provide a maintenance planner with customizable task times for a maintenance session.

For example, in an advantageous embodiment, a calculated time increment may be applied to each individual task. These time increments can be tallied together by time module 612 to provide a time increment for larger task sets, and for the maintenance session as a whole. Assessment module 608 may provide information on the available time increments for individual resources, such as personnel, tools, and workspace.

In an illustrative example, time module 612 may calculate the total available time increment for personnel, and adjust that available time increment as time elapses to reflect the remaining available time for personnel. In another illustrative example time module 612 may adjust the available time increment for personnel by adding required labor breaks or gaps into the total activity time in order to more accurately reflect real world execution.

In an advantageous embodiment, the individual task time increments may be modified as needed to more accurately reflect the capabilities of a group of personnel or a worksite. For example, in an advantageous embodiment, an individual task may normally be assigned a time increment of one hour to complete with the assumption that two maintenance personnel would simultaneously execute the task. However, an organization with only one available maintenance personnel may adjust the time increment for that individual task to reflect the actual time it will take only one maintenance worker to complete the individual task. Time module 612 may also calculate and compare past times recorded by maintenance planning tool 600 in order to better estimate future time increments for planning purposes.

Filters 614 insulate the information available in the plurality of databases and limit the data or information a planner is allowed to access with download module 606. Filters 614 may be an example of a security measure to ensure confidentiality of proprietary information of products when multiple customers of different products utilize the maintenance planning tool and access the number of databases. For example, when a user requests information from the number of databases, such as plurality of databases 502 in FIG. 5, in order to form a maintenance plan, filter 614 may determine the access level granted to the user and restrict or allow information according to the access level of the user.

In one advantageous embodiment, a user may be a customer of one model of aircraft, and the information contained in the number of databases may pertain to a number of different models of aircraft, including proprietary information. The user may be restricted to access only information pertaining to the model of aircraft for that customer, or information pertaining to models of aircraft that the customer is allowed to access.

Filters 614 may also be an example of an efficiency measure to ensure that only information applicable to the particular product for which a maintenance plan is being developed is assessed and compiled by assessment module 606 and compiler module 610. For example, in an advantageous embodiment, the number of databases may contain information about a number of different models of aircraft, and filter 614 may only return information pertaining to the model for which the maintenance plan is being developed.

Status monitor 616 may be an interactive feature of maintenance planning tool 600 to allow a planner to monitor the status of a particular maintenance plan that is currently in effect or on-going. For example, a maintenance planner may have developed a maintenance plan using maintenance planning tool 600 for a particular aircraft. The maintenance plan may be scheduled for the entire weekend given the number of tasks to be completed within the maintenance session executing the maintenance plan. The maintenance planner may periodically check on the status of the work to see what tasks in the maintenance plan have already been completed, what tasks remain, and whether the series of tasks are being completed on schedule according to the time estimate computed by time module 612.

With reference now to FIG. 7, a diagram of a user interface is depicted in accordance with an advantageous embodiment. User interface 700 is an example of one implementation of user interface 602 in FIG. 6.

User interface 700 includes drag/drop module 702 and touch screen 704. User interface 700 may be integrated with a display, such as display 604 in FIG. 6, allowing a user to manipulate the information displayed using touch screen 704 and drag/drop module 702. Drag/drop module 702 allows a user to select an object displayed in one location and move the object to another location. For example, user interface 700 may display a series of tasks or events that need to be completed in a particular maintenance session.

A user may use drag/drop module 702 to select one task or event in the series of tasks or events, and move the task to another location within the series. The selection and movement of an object may be accomplished utilizing a peripheral, such as a keyboard or mouse, or alternatively may be accomplished using touchscreen 704.

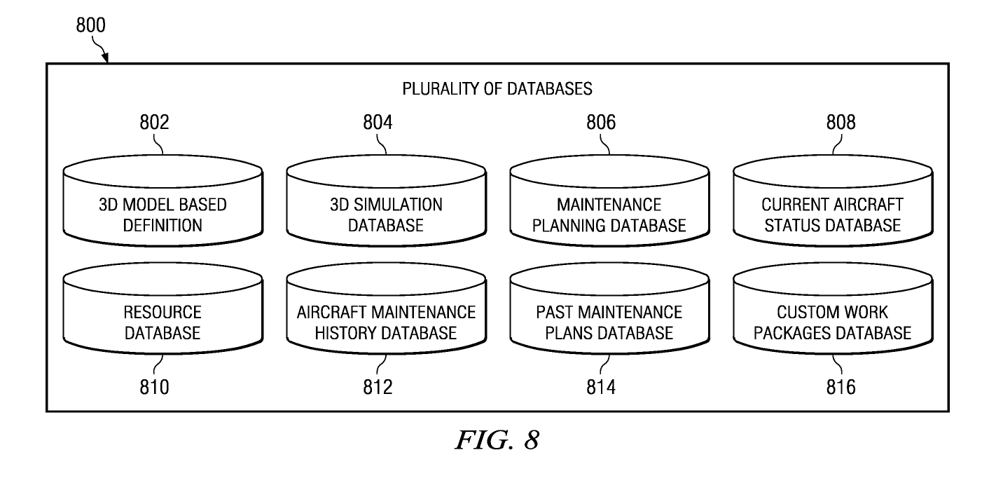

With reference now to FIG. 8, a diagram of a plurality of databases is depicted in accordance with an advantageous embodiment. Plurality of databases 800 is an example of one implementation for plurality of databases 502 in FIG. 5.

Plurality of databases 800 includes three dimensional model based definition 802, three dimensional simulation database 804, maintenance planning database 806, current aircraft status database 808, resource database 810, aircraft maintenance history database 812, past maintenance plans database 814, and custom work packages database 816.

Three dimensional model based definition 802 contains the three dimensional model based definitions and identification information for a number of different aircraft models. Identification information for different aircraft models may include, without limitation, major and minor model numbers, tail numbers, customer unique numbers, engineering and manufacturing effectivity numbers, and the like. Past modification information, component or configuration options that are exercised, status on service bulletin incorporation, past repair information, and/or any manufacturing deviations would all be reflected in the configuration of the aircraft models to provide a more accurate visual depiction of the actual product.

Three dimensional simulation database 804 contains a number of three dimensional simulations of tasks and events related to maintenance and service of an aircraft. Each simulation depicts one task or event in a number of tasks or events. These simulations can be pieced together to form a flow of tasks or events that make up a maintenance plan. A three dimensional task simulation may be a number of tasks. As used herein, a number refers to one or more tasks. For example, a planner utilizing user interface 700 in FIG. 7 may use drag/drop module 702 to order the individual task or event simulations into a flow of task or event simulations to generate a maintenance plan. In another embodiment, maintenance planning tool 600 in FIG. 6 may arrange the individual task or event simulations into the most efficient order to generate a maintenance plan.

Maintenance planning database 806 contains maintenance planning data for each aircraft model defined in three dimensional model based definition 802. This maintenance planning data describes what preventative maintenance must be performed to maintain airworthiness and federal compliance for a given aircraft. This information may include regulatory requirements and service bulletins.

Current aircraft status database 808 contains reports of current squawks or failures occurring on a given aircraft. These reports may be used in conjunction with the maintenance planning data from maintenance planning database 806 to develop a customized list of tasks required for a particular maintenance session. In an advantageous embodiment, the customized list is developed by maintenance planning tool 600 in FIG. 6. For example, assessment module 608 analyzes the maintenance planning data and current status reports to determine the tasks or events needed in the maintenance session.

Compiler module 610 then takes the task or event simulations retrieved by download module 606 from a database, such as three dimensional simulation database 804, and together with assessment module 608 generates an order of three dimensional task simulations that can be viewed and modified by the planner.

Resource database 810 contains information about the resources available and/or necessary for a maintenance session. Resources may include, for example, without limitation, personnel, tools, workspace, supplies, and the like.

Aircraft maintenance history database 812 contains information about the maintenance history for a given aircraft. The maintenance history of an aircraft can be used in conjunction with the maintenance planning data to determine what regulatory and/or compliance measures need to be taken in the next maintenance session in order to maintain airworthiness and federal compliance.

Past maintenance plans database 814 contains the stored maintenance plans previously created by a maintenance planning tool. These past plans may be stored, and then reused, or may be modified to generate a new plan. For example, a past maintenance plan for one aircraft may be copied and executed on another aircraft of the same model or in the same fleet.

Custom work packages database 816 contains information on custom work packages that can be authored, saved, and reused on other aircraft for more consistent, efficient fleet maintenance management. For example, entire heavy check work packages could be copied, modified, and then executed on multiple airframes.

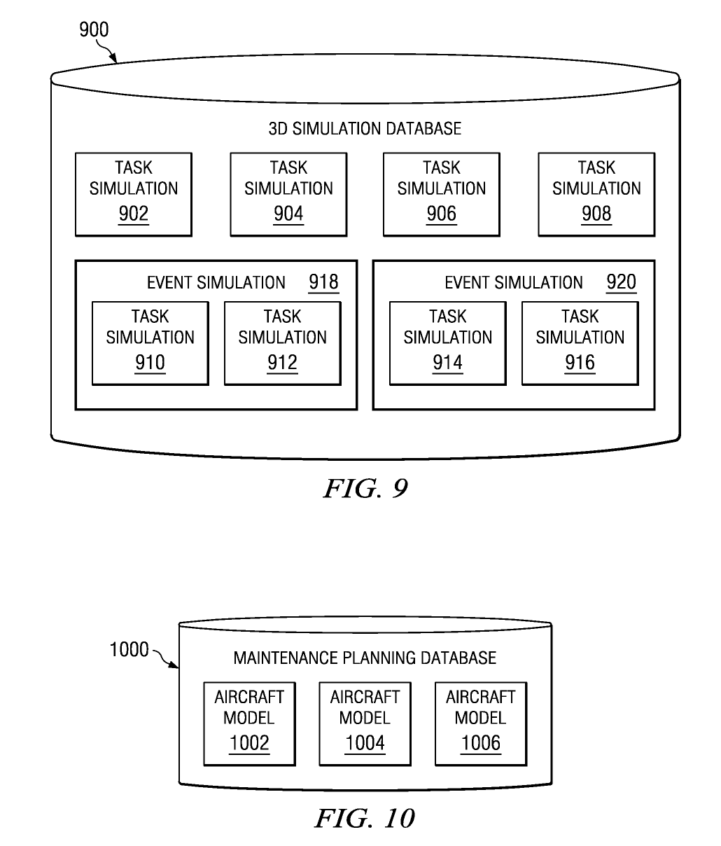

With reference now to FIG. 9, a diagram of a three dimensional simulation database is depicted in accordance with an advantageous embodiment. Three dimensional simulation database 900 is an example of one implementation of three dimensional simulation database 804 in FIG. 8.

Three dimensional simulation database 900 contains a number of three dimensional simulations of tasks and events related to maintenance and service of an aircraft. Three dimensional simulation database 900 includes task simulation 902, task simulation 904, task simulation 906, task simulation 908, task simulation 910, task simulation 912, task simulation 914, task simulation 916, event simulation 918, and event simulation 920. Each simulation depicts one task or event in a number of tasks or events. For example, task simulation 902 may be removal of a component, and task simulation 904 may be installation of a component.

Groups of individual task simulations may be combined to create an event simulation, such as event simulation 918 or event simulation 920. Event simulation 918 includes task simulation 910 and task simulation 912. These simulations can be pieced together to form a sequence of tasks or events that make up a maintenance plan. In one advantageous embodiment, each task simulation may be individually selected and ordered into a particular sequence of tasks. For example, in an advantageous embodiment, a sequence of tasks or events may be: (a) prepare product for maintenance, (b) access component, (c) execute fault isolation procedures, (d) execute component removal procedures, (e) execute component installation procedures, (f) execute servicing procedures, (g) execute test procedures, (h) execute close procedures, and (i) return product to service procedures.

In another advantageous embodiment, an event simulation may be selected with a pre-arranged order to task simulations, such as event simulation 918. In yet another advantageous embodiment, an event simulation may be selected with pre-arranged task simulations, and the pre-arranged task simulations may be modified or re-arranged by a maintenance planner. For example, a planner utilizing user interface 700 in FIG. 7 may use drag/drop module 702 to order the individual task or event simulations into a flow of task or event simulations to generate a maintenance plan. In another embodiment, maintenance planning tool 600 in FIG. 6 may arrange the individual task or event simulations into the most efficient order to generate a maintenance plan.

With reference now to FIG. 10, a diagram of a maintenance planning database is depicted in accordance with an advantageous embodiment. Maintenance planning database 1000 is an example of one implementation for maintenance planning database 806 in FIG. 8.

In this advantageous example, maintenance planning database 1000 contains maintenance planning data for aircraft model 1002, aircraft model 1004, and aircraft model 1006. Aircraft model 1002, aircraft model 1004, and aircraft model 1006 are illustrative of each aircraft model defined in three dimensional based definition 802 in FIG. 8. This maintenance planning data describes what preventative maintenance must be performed to maintain airworthiness and federal compliance for a given aircraft.

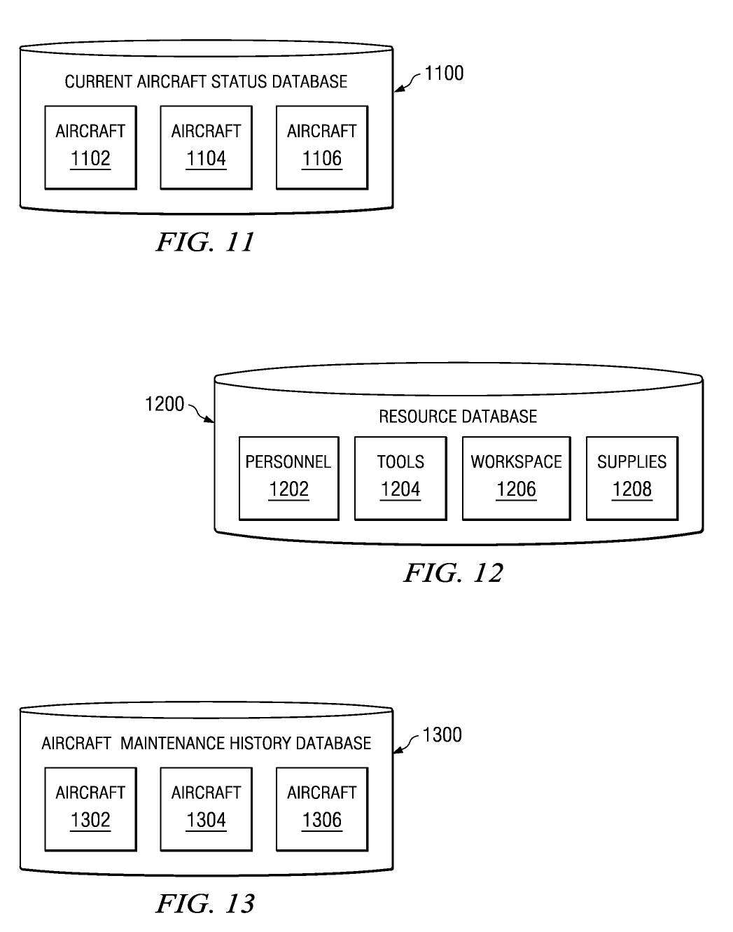

With reference now to FIG. 11, a diagram of a current aircraft status database is depicted in accordance with an advantageous embodiment. Current aircraft status database 1100 is an example of current aircraft status database 808 in FIG. 8.

Current aircraft status database 1100 contains reports of current squawks or failures occurring on aircraft 1102, aircraft 1104, and aircraft 1106. These reports may be used in conjunction with the maintenance planning data from maintenance planning database 1000 to develop a customized list of tasks required for a particular maintenance session. In an advantageous embodiment, the customized list is developed by maintenance planning tool 600 in FIG. 6. For example, assessment module 608 analyzes the maintenance planning data and current status reports to determine the tasks or events needed in the maintenance session. Compiler module 610 then takes the task or event simulations retrieved by download module 606 from a database, such as three dimensional simulation database 900, and together with assessment module 608 generates an order of three dimensional task simulations that can be viewed and modified by the planner.

With reference now to FIG. 12, a diagram of a resource database is depicted in accordance with an advantageous embodiment. Resource database 1200 is an example of one implementation of resource database 810 in FIG. 8.

Resource database 1200 contains information about the resources available and/or necessary for a maintenance session. Resources 1200 includes personnel 1202, tools 1204, workspace 1206, and supplies 1208. Personnel 1202 may include lists of maintenance personnel for a particular aircraft model, authorized personnel, required personnel, available personnel, on-duty personnel, and the like. Personnel 1202 is used by maintenance planning tool 600 to determine which personnel are required and/or available for a particular maintenance session, which may impact the flow of tasks or events in the maintenance session.

For example, if only two maintenance personnel are available to work on the particular aircraft during the timeframe in which the maintenance session must occur, the tasks and events must be ordered in such as way that two maintenance personnel are able to complete each task in that order without the assistance of additional personnel.

Tools 1204 may include information about the tools that are required, available, or unavailable at given periods of time and for given aircraft models. For example, a particular worksite may have only one of a certain tool, which is required for two different tasks during the maintenance session. The two different tasks that both require the same tool must not be ordered to occur simultaneous to each other given that only one tool is available.

Workspace 1206 may include information about a number of worksites where maintenance sessions may take place. Information about worksites may include the size of the workspace, the hours of operation, the list of scheduled maintenance sessions for that worksite, the availability of that worksite, and the like.

Supplies 1208 may include information about the supplies necessary to complete the maintenance session. Supplies may include replacement parts, new parts, additional parts, and the like.

With reference now to FIG. 13, a diagram of an aircraft maintenance history database is depicted in accordance with an advantageous embodiment. Aircraft maintenance history database 1300 is an example of one manner in which aircraft maintenance history database 812 in FIG. 8 may be implemented.

Aircraft maintenance history database 1300 contains information about the maintenance history for aircraft 1302, aircraft 1304, and aircraft 1306. The maintenance history of aircraft 1302, aircraft 1304, and aircraft 1306 can be used in conjunction with the maintenance planning data to determine what regulatory and/or compliance measures need to be taken in the next maintenance session in order to maintain airworthiness and federal compliance.

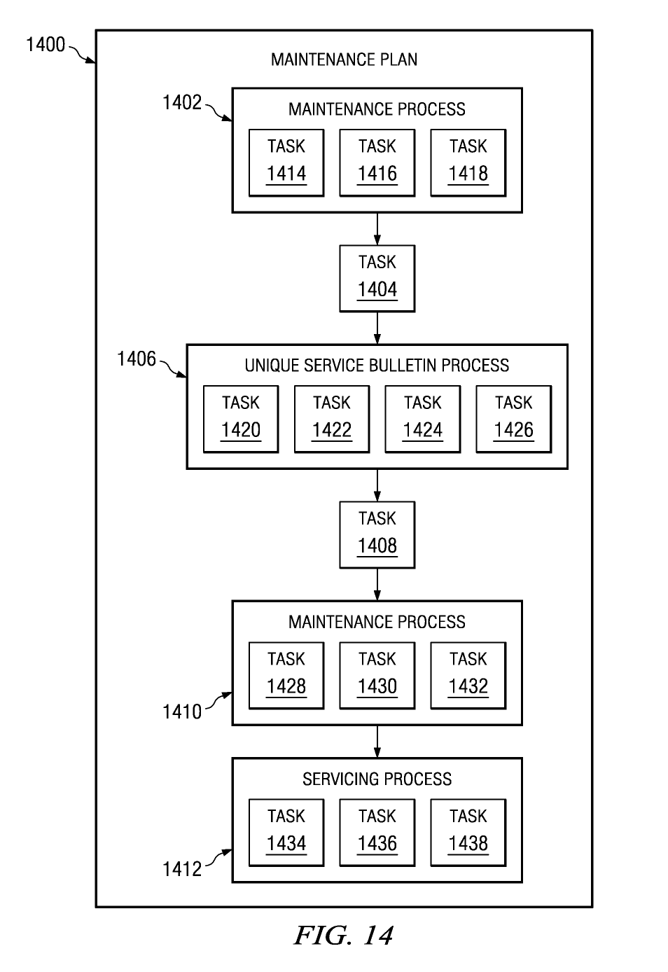

With reference now to FIG. 14, a diagram of a three dimensional maintenance plan generated by a three dimensional maintenance planning tool is depicted in accordance with an advantageous embodiment. Maintenance plan 1400 is an example of one implementation of a maintenance plan generated by maintenance planning tool 600 in FIG. 6.

Maintenance plan 1400 includes maintenance process 1402, task 1404, unique service bulletin process 1406, task 1408, maintenance process 1410, and servicing process 1412. Maintenance process 1402 includes task 1414, task 1416, and task 1418. In an advantageous embodiment, maintenance process 1402 is the process to prepare the aircraft for maintenance. Task 1414 is the process to set the parking brakes, task 1416 is the process to install landing gear downlock pins, and task 1418 is the process to provide ground power.

Task 1404 is a transition task from maintenance process 1402 to unique service bulletin process 1406. In an advantageous embodiment, unique service bulletin process 1406 may be the process to inspect for corrosion. Task 1404 may be the process to open an access panel.

In an advantageous embodiment, servicing process 1412 may be the process of adding oil or grease to a component.

The different processes illustrated for maintenance plan 1400 in FIG. 14 are not meant to provide architectural limitations to the manner in which different embodiments may be implemented. The different advantageous embodiments may be implemented using processes or tasks in addition to or in place of those illustrated for maintenance plan 1400. The different embodiments may be implemented using any task or event related to maintenance and/or repair of a product.

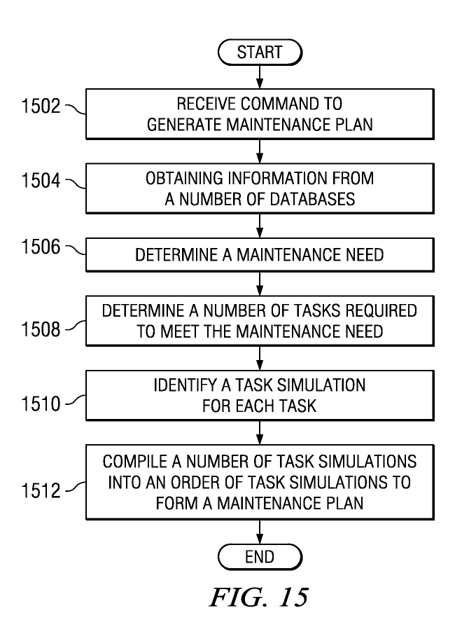

With reference now to FIG. 15, a flowchart illustrating a process for generating a maintenance plan is depicted in accordance with an advantageous embodiment. The process in FIG. 15 may be implemented in a component such as, for example, maintenance planning tool 600 in FIG. 6.

The process begins by receiving a command to generate a maintenance plan (operation 1502). The command may be generated from, for example, without limitation, user input, a routine scheduled maintenance alert, or a fault detection in an aircraft. Next, the process obtains information from a number of databases (operation 1504). The process may use a download module, such as download module 606 in FIG. 6, to download information from a plurality of databases, such as plurality of databases 800 in FIG. 8.

The process then determines a maintenance need (operation 1506) and determines a number of tasks required to meet the maintenance need (operation 1508). The process identifies a task simulation for each task in the number of tasks required to meet the maintenance need (operation 1510). The task simulations may be obtained using three dimensional simulation database 900 in FIG. 9. Then, the process compiles the number of task simulations into an order of task simulations to form a maintenance plan (operation 1512), with the process terminating thereafter.

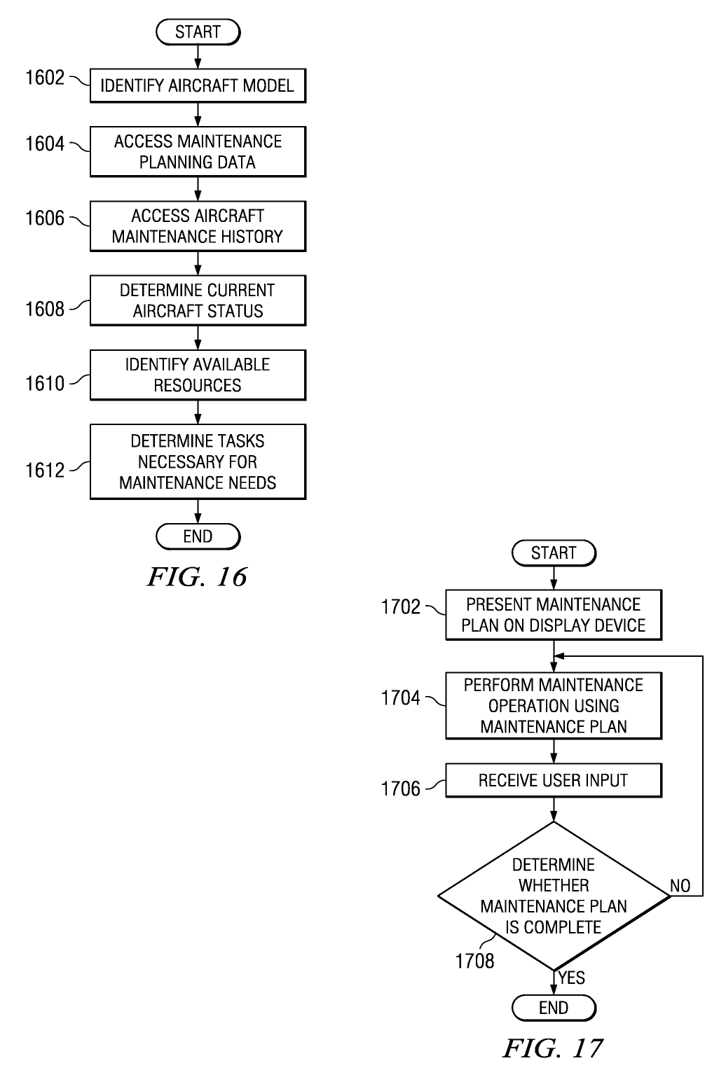

With reference now to FIG. 16, a flowchart illustrating a process for determining maintenance needs is depicted in accordance with an advantageous embodiment. The process in FIG. 16 may be implemented in a component, such as, for example, maintenance planning tool 600 in FIG. 6.

The process begins by identifying the aircraft model requiring maintenance (operation 1602). The aircraft model may be identified using information received from user input, such as the tail number of the aircraft, and checked against a database, such as three dimensional model based definition 802 in FIG. 8. Next, the process accesses maintenance planning data (operation 1604) to determine what preventative maintenance must be performed to maintain airworthiness and federal compliance for a given aircraft. This may include regulatory requirements and service bulletins.

The process then accesses aircraft maintenance history (operation 1606) to determine what maintenance the aircraft has received in the past. This information may be accessed using aircraft maintenance history database 812 in FIG. 8, for example. In an advantageous embodiment, this determination may aid in determining what regulatory requirements have already been addressed and what requirements still need to be addressed.

The process determines the current aircraft status (operation 1608) using reports about current problems or failures with the aircraft. Information about current problems or failures may be obtained from current aircraft status database 808 in FIG. 8, for example.

Next, the process identifies the available resources (operation 1610) for the maintenance needs and the particular aircraft. The available resources may be identified using resources database 810 in FIG. 8, for example. The process then determines the tasks necessary to address the maintenance needs of the aircraft (operation 1612), with the process terminating thereafter.

With reference now to FIG. 17, a flowchart illustrating a process for performing a maintenance operation is depicted in accordance with an advantageous embodiment. The process in FIG. 17 may be implemented by a human user interacting with a component, such as, for example, maintenance planning tool 600 in FIG. 6.

The process begins by presenting a maintenance plan on a display device (operation 1702). The display device may be, for example, display 414 in FIG. 4. The process performs a maintenance operation using the maintenance plan (operation 1704). The maintenance operation may be performed by a number of human operators, such as maintenance workers, for example. As used herein, a number refers to one or more human operators. Next, the process receives user input (operation 1706). The user input may be a status report from a human operator, for example. The process determines whether the maintenance plan is complete (operation 1708). If the maintenance plan is not complete, the process returns to operation 1704. If the maintenance plan is complete, the process terminates.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of computer usable or readable program code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The different advantageous embodiments can take the form of an entirely hardware embodiment, an entirely software embodiment, or an embodiment containing both hardware and software elements. Some embodiments are implemented in software, which includes but is not limited to forms, such as, for example, firmware, resident software, and microcode.

Furthermore, the different embodiments can take the form of a computer program product accessible from a computer-usable or computer-readable medium providing program code for use by or in connection with a computer or any device or system that executes instructions. For the purposes of this disclosure, a computer-usable or computer readable medium can generally be any tangible apparatus that can contain, store, communicate, propagate, or transport the program for use by or in connection with the instruction execution system, apparatus, or device.

The computer usable or computer readable medium can be, for example, without limitation an electronic, magnetic, optical, electromagnetic, infrared, or semiconductor system, or a propagation medium. Non limiting examples of a computer-readable medium include a semiconductor or solid state memory, magnetic tape, a removable computer diskette, a random access memory (RAM), a read-only memory (ROM), a rigid magnetic disk, and an optical disk. Optical disks may include compact disk-read only memory (CD-ROM), compact disk-read/write (CD-R/W) and DVD.

Further, a computer-usable or computer-readable medium may contain or store a computer readable or usable program code such that when the computer readable or usable program code is executed on a computer, the execution of this computer readable or usable program code causes the computer to transmit another computer readable or usable program code over a communications link. This communications link may use a medium that is, for example without limitation, physical or wireless.

A data processing system suitable for storing and/or executing computer readable or computer usable program code will include one or more processors coupled directly or indirectly to memory elements through a communications fabric, such as a system bus. The memory elements may include local memory employed during actual execution of the program code, bulk storage, and cache memories which provide temporary storage of at least some computer readable or computer usable program code to reduce the number of times code may be retrieved from bulk storage during execution of the code.

Input/output or I/O devices can be coupled to the system either directly or through intervening I/O controllers. These devices may include, for example, without limitation to keyboards, touch screen displays, and pointing devices. Different communications adapters may also be coupled to the system to enable the data processing system to become coupled to other data processing systems or remote printers or storage devices through intervening private or public networks. Non-limiting examples are modems and network adapters are just a few of the currently available types of communications adapters.

The description of the different advantageous embodiments has been presented for purposes of illustration and description, and is not intended to be exhaustive or limited to the embodiments in the form disclosed. Many modifications and variations will be apparent to those of ordinary skill in the art. For example, although the different advantageous embodiments have been described with respect to aircraft, other advantageous embodiments may be applied to other types of objects. For example, without limitation, other advantageous embodiments may be applied to a mobile platform, a stationary platform, a land-based structure, an aquatic-based structure, a space-based structure and/or some other suitable object. More specifically, the different advantageous embodiments may be applied to, for example, without limitation, a submarine, a bus, a personnel carrier, tank, a train, an automobile, a spacecraft, a space station, a satellite, a surface ship, a power plant, a dam, a manufacturing facility, a building and/or some other suitable object.

Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

Alternative embodiments may be claimed as follows:

A1. A method for generating maintenance plans, the method comprising:

responsive to receiving a request to generate a maintenance plan for a structure, obtaining information from a number of databases;

determining a maintenance need for the structure using the information obtained from the number of databases;

determining a number of tasks required to meet the maintenance need using the information obtained from the number of databases;

identifying a three dimensional task simulation for each task in the number of tasks required to meet the maintenance need using the information obtained from the number of databases to form a number of three dimensional task simulations; and

compiling the number of three dimensional task simulations for the number of tasks required into a sequence of three dimensional task simulations to form the maintenance plan.

A2. The method of claim A1, wherein the structure is selected from one of a mobile platform, a stationary platform, a land-based structure, an aquatic-based structure, a space-based structure, an aircraft, a surface ship, a tank, a personnel carrier, a train, a spacecraft, a space station, a satellite, a submarine, an automobile, a power plant, a bridge, a dam, a manufacturing facility, and a building.

B1. An apparatus for generating maintenance plans, the apparatus comprising:

a display;

a storage device storing a display process; and

a processor unit connected to the display and storage device, the processor unit configured to execute the display process to perform presenting a display of a number of maintenance plans; responsive to receiving a request to generate a maintenance plan for a structure, obtaining information from a number of databases; determining a maintenance need for the structure using the information obtained from the number of databases; determining a number of tasks required to meet the maintenance need using the information obtained from the number of databases; identifying a three dimensional task simulation for each task in the number of tasks required to meet the maintenance need using the information obtained from the number of databases to form a number of three dimensional task simulations; and compiling the number of three dimensional task simulations for the number of tasks required into a sequence of three dimensional task simulations to form the maintenance plan.

B2. The apparatus of claim B1, wherein the number of three dimensional task simulations are rearranged using a drag and drop function.

B3. The apparatus of claim B2, wherein the drag and drop function is implemented on a touch screen.

B4. The apparatus of claim B1, wherein the structure is selected from one of a mobile platform, a stationary platform, a land-based structure, an aquatic-based structure, a space-based structure, an aircraft, a surface ship, a tank, a personnel carrier, a train, a spacecraft, a space station, a satellite, a submarine, an automobile, a power plant, a bridge, a dam, a manufacturing facility, and a building.

B5. The apparatus of claim 25, wherein the number of databases include at least one of an engineering database containing three dimensional model based definitions of a number of structures, a database of three dimensional task simulations, a database of regulatory requirements, a database of federal compliance standards, a database of current structure status for each of the number of structures, a resource database, a maintenance history database, a database of past maintenance plans, and a custom work packages database.

B6. The apparatus of claim B5, wherein the number of structures in the engineering database containing three dimensional model based definitions are a number of aircraft.

B7. The apparatus of claim B5, wherein the database of regulatory requirements contain regulatory requirements for airworthiness.

B8. The apparatus of claim B5, wherein the database of federal compliance standards contain federal compliance standards for aircraft.

B9. The apparatus of claim B5, wherein the database of current structure status contains current aircraft status for a number of aircraft.

B10. The apparatus of claim B5, wherein the resource database contains information about available resources and required resources for the number of tasks required to meet the maintenance need.

B11. The apparatus of claim B5, wherein the maintenance history database contains records of maintenance history for the structure.

B12. The apparatus of claim B5, wherein the database of past maintenance plans contains final maintenance plans previously performed on one or more of the number of structures.

B13. The apparatus of claim B5, wherein the custom work packages database contains custom work packages previously generated for one or more of the number of structures.

B14. The apparatus of claim B5, wherein the processor unit is configured to execute the display process to perform determining the maintenance need for the structure and is further configured to execute the display process to perform:

comparing the information obtained from the database of current aircraft status for the number of aircraft with the information obtained from the database of regulatory requirements and the database of federal compliance standards for aircraft.

C1. A computer program product on a computer readable storage medium with computer usable program code for generating maintenance plans, the computer program product comprising:

computer usable program code for, responsive to receiving a request to generate a maintenance plan for a structure, obtaining information from a number of databases;

computer usable program code for determining a maintenance need for the structure using the information obtained from the number of databases;

computer usable program code for determining a number of tasks required to meet the maintenance need using the information obtained from the number of databases;

computer usable program code for identifying a three dimensional task simulation for each task in the number of tasks required to meet the maintenance need using the information obtained from the number of databases to form a number of three dimensional task simulations; and

computer usable program code for compiling the number of three dimensional task simulations for the number of tasks required into a sequence of three dimensional task simulations to form the maintenance plan.

C2. The computer program product of claim C1, wherein the structure is selected from one of a mobile platform, a stationary platform, a land-based structure, an aquatic-based structure, a space-based structure, an aircraft, a surface ship, a tank, a personnel carrier, a train, a spacecraft, a space station, a satellite, a submarine, an automobile, a power plant, a bridge, a dam, a manufacturing facility, and a building.

C3. The computer program product of claim C1, wherein the number of databases include at least one of an engineering database containing three dimensional model based definitions of a number of structures, a database of three dimensional task simulations, a database of regulatory requirements, a database of federal compliance standards, a database of current structure status for each of the number of structures, a resource database, a maintenance history database, a database of past maintenance plans, and a custom work packages database.

C4. The computer program product of claim C3, wherein the number of structures in the engineering database containing three dimensional model based definitions are a number of aircraft.

C5. The computer program product of claim C3, wherein the database of regulatory requirements contain regulatory requirements for airworthiness.

C6. The computer program product of claim C3, wherein the database of regulatory requirements contain regulatory requirements for airworthiness.

C7. The computer program product of claim C3, wherein the database of current structure status contains current aircraft status for a number of aircraft.

C8. The computer program product of claim C3, wherein the resource database contains information about available resources and required resources for the number of tasks required to meet the maintenance need.

C9. The computer program product of claim C3, wherein the maintenance history database contains records of maintenance history for the structure.

C10. The computer program product of claim C3, wherein the database of past maintenance plans contains final maintenance plans previously performed on one or more of the number of structures.

C11. The computer program product of claim C3, wherein the custom work packages database contains custom work packages previously generated for one or more of the number of structures.

C12. The computer program product of claim C3, wherein determining the maintenance need for the structure further comprises:

computer usable program code for comparing the information obtained from the database of current aircraft status for the number of aircraft with the information obtained from the database of regulatory requirements and the database of federal compliance standards for aircraft

What is claimed is:

1. A method for generating maintenance plans, the method comprising:
responsive to receiving a request to generate a maintenance plan for a structure, obtaining information from a number of databases;
determining a maintenance need for the structure using the information obtained from the number of databases;
determining a number of tasks required to meet the maintenance need using the information obtained from the number of databases;
identifying a three dimensional task simulation for each task in the number of tasks required to meet the maintenance need using the information obtained from the number of databases to form a number of three dimensional task simulations; and
compiling the number of three dimensional task simulations for the number of tasks required into a sequence of three dimensional task simulations to form the maintenance plan.

2. The method of claim 1, wherein the information from the number of databases includes at least one of a model definition for the structure, the number of three dimensional task simulations, regulatory requirements for the structure, federal compliance standards for the structure, current structure status for a number of structures, available resources, required resources for the number of tasks, maintenance history for the structure, past maintenance plans for the structure, and a number of custom work packages.

3. The method of claim 1, further comprising at least one of:
allowing the number of three dimensional task simulations in the sequence of three dimensional task simulations to be repeatedly rearranged into a number of different sequences of three dimensional task simulations to form a number of maintenance plans; and
arranging the number of three dimensional task simulations to represent an actual maintenance event, wherein the actual maintenance event requires both simultaneous and sequential tasks.

4. The method of claim 3, wherein the number of three dimensional task simulations are rearranged using a drag and drop function.

5. The method of claim 4, wherein the drag and drop function is implemented on a touch screen.

6. The method of claim 3, further comprising at least one of:
detecting conflicts in at least one of the number of maintenance plans based on the sequence of three dimensional task simulations;
selecting a final maintenance plan based on the sequence of three dimensional task simulations;
performing maintenance on the structure using the final maintenance plan; and
storing the final maintenance plan in a database of past maintenance plans.

7. The method of claim 1, wherein the number of databases include at least one of an engineering database containing three dimensional model based definitions of a number of structures, a database of three dimensional task simulations, a database of regulatory requirements, a database of federal compliance standards, a database of current structure status for each of the number of structures, a resource database, a maintenance history database, a database of past maintenance plans, and a custom work packages database.

8. The method of claim 7, wherein the number of structures in the engineering database containing three dimensional model based definitions are a number of aircraft; wherein the database of regulatory requirements contain regulatory requirements for airworthiness; wherein the database of federal compliance standards contain federal compliance standards for aircraft; wherein the database of current structure status contains current aircraft status for a number of aircraft; wherein the resource database contains information about available resources and required resources for the number of tasks required to meet the maintenance need; wherein the maintenance history database contains records of maintenance history for the structure; wherein the database of past maintenance plans contains final maintenance plans previously performed on one or more of the number of structures; and wherein the custom work packages database contains custom work packages previously generated for one or more of the number of structures.

9. The method of claim 7, wherein determining the maintenance need for the structure further comprises:
comparing the information obtained from the database of current aircraft status for the number of aircraft with the information obtained from the database of regulatory requirements and the database of federal compliance standards for aircraft.

10. The method of claim 1, further comprising at least one of:
filtering the information obtained from the number of databases to form filtered information, wherein the filtered information is specific to a model of the structure;
determining an access level for a user sending the request; and
restricting the information obtained according to the access level.

11. An apparatus for generating maintenance plans, the apparatus comprising:
a display;
a storage device storing a display process; and
a processor unit connected to the display and storage device, the processor unit configured to execute the display process to perform presenting a display of a number of maintenance plans; responsive to receiving a request to generate a maintenance plan for a structure, obtaining information from a number of databases; determining a maintenance need for the structure using the information obtained from the number of databases; determining a number of tasks required to meet the maintenance need using the information obtained from the number of databases; identifying a three dimensional task simulation for each task in the number of tasks required to meet the maintenance need using the information obtained from the number of databases to form a number of three dimensional task simulations; and compiling the number of three dimensional task simulations for the number of tasks required into a sequence of three dimensional task simulations to form the maintenance plan.

12. The apparatus of claim 11, wherein the information from the number of databases includes at least one of a model definition for the structure, the number of three dimensional task simulations, regulatory requirements for the structure, federal compliance standards for the structure, current structure status for a number of structures, available resources, required resources for the number of tasks, maintenance history for the structure, past maintenance plans for the structure, and a number of custom work packages.

13. The apparatus of claim 11, wherein the processor unit is further configured to execute the display process to perform at least one of:
allowing the number of three dimensional task simulations in the sequence of three dimensional task simulations to be repeatedly rearranged into a number of different sequences of three dimensional task simulations to form a number of maintenance plans;
arranging the number of three dimensional task simulations to represent an actual maintenance event, wherein the actual maintenance event requires both simultaneous and sequential tasks;
detecting conflicts in at least one of the number of maintenance plans based on the sequence of three dimensional task simulations;
selecting a final maintenance plan based on the sequence of three dimensional task simulations;
performing maintenance on the structure using the final maintenance plan; and
storing the final maintenance plan in a database of past maintenance plans.

14. The apparatus of claim 11, wherein the processor unit is further configured to execute the display process to perform at least one of:
filtering the information obtained from the number of databases to form filtered information, wherein the filtered information is specific to a model of the structure;
determines an access level for a user sending the request; and
restricting the information obtained according to the access level.

15. A computer program product on a computer readable storage medium with computer usable program code for generating maintenance plans, the computer program product comprising:
computer usable program code for, responsive to receiving a request to generate a maintenance plan for a structure, obtaining information from a number of databases;
computer usable program code for determining a maintenance need for the structure using the information obtained from the number of databases;
computer usable program code for determining a number of tasks required to meet the maintenance need using the information obtained from the number of databases;
computer usable program code for identifying a three dimensional task simulation for each task in the number of tasks required to meet the maintenance need using the information obtained from the number of databases to form a number of three dimensional task simulations; and
computer usable program code for compiling the number of three dimensional task simulations for the number of tasks required into a sequence of three dimensional task simulations to form the maintenance plan.

16. The computer program product of claim 15, wherein the information from the number of databases includes at least one of a model definition for the structure, the number of three dimensional task simulations, regulatory requirements for the structure, federal compliance standards for the structure, current structure status for a number of structures, available resources, required resources for the number of tasks, maintenance history for the structure, past maintenance plans for the structure, and a number of custom work packages.

17. The computer program product of claim 15, further comprising at least one of:
computer usable program code for allowing the number of three dimensional task simulations in the sequence of three dimensional task simulations to be repeatedly rearranged into a number of different sequences of three dimensional task simulations to form a number of maintenance plans;
computer usable program code for arranging the number of three dimensional task simulations to represent an actual maintenance event, wherein the actual maintenance event requires both simultaneous and sequential tasks; computer usable program code for detecting conflicts in at least one of the number of maintenance plans based on the sequence of three dimensional task simulations;
computer usable program code for selecting a final maintenance plan based on the sequence of three dimensional task simulations;
computer usable program code for performing maintenance on the structure using the final maintenance plan; and
computer usable program code for storing the final maintenance plan in a database of past maintenance plans.

18. The computer program product of claim 17, wherein the number of three dimensional task simulations are rearranged using a drag and drop function.

19. The computer program product of claim 18, wherein the drag and drop function is implemented on a touch screen.

20. The computer program product of claim 15, further comprising at least one of:
computer usable program code for filtering the information obtained from the number of databases to form filtered information, wherein the filtered information is specific to a model of the structure;
computer usable program code for determining an access level for a user sending the request; and
computer usable program code for restricting the information obtained according to the access level.
